(19) United States
(12) Patent Application Publication
(10) Pub. No.: US 2014/0003780 A1
(43) Pub. Date: Jan. 2, 2014

(54) Passive Periodic-Slot Waveguide As An Optical Filter And Phase Reference

(71) Applicant: BAE Systems Information and Electronic Systems Integration Inc., (US)

(72) Inventor: Robert L. Kamocsai, Manassas, VA (US)

(73) Assignee: BAE Systems Information and Electronic Systems Integration Inc., Nashua, NH (US)

(21) Appl. No.: 13/780,200

(22) Filed: Feb. 28, 2013

Related U.S. Application Data
(60) Provisional application No. 61/665,352, filed on Jun. 28, 2012.

(51) Int. Cl. G02B 5/26

(52) U.S. Cl. CPC G02B 5/265
USPC 385/129

(57) ABSTRACT

A device that filters optical signals using a waveguide having a slotted optical pathway. The shape of the optical pathway passively restricts at least one optical signal from traveling through the waveguide. The device can also be used to reference the phase of an optical signal in an optical circuit.

### RELATED APPLICATIONS

This Application claims rights under 35 U.S.C. §119(e) from U.S. Application Ser. No. 61/665,352 filed Jun. 28, 2012, the contents of which are incorporated herein by reference.

### TECHNICAL FIELD

Various embodiments described herein relate to optical filters generally, including an optical filter for allowing only certain optical signals to pass through the optical filter and methods for filtering optical signals and manufacturing optical filters.

### BACKGROUND

Optical filters are devices that selectively transmit optical signals of a desired wavelength. Typically these devices require an external input to adjust the optical filter allowing the desired optical signal to pass through the filter. For example, an external input may he n electrical input from external circuitry associated with the optical filter. These devices are typically complex units because the external electrical circuitry requires additional components and in some instances operating software. As a result, these devices may be expensive to manufacture.

Moreover, the complexity of these optical filters increases the operating costs and reduces operating efficiency for these devices. Additional operating cost increases may result from software maintenance, such as debugging or software upgrades, that may be required for optical filter operation.

Other devices may require an operator to manually adjust the optical filter by re-positioning filter components to achieve the desired filtering effect. These optical filters are typically less complicated than those filters requiring external circuitry. These devices, however, usually incorporate larger components. As a result, these optical filters tend to be larger devices requiring additional space to operate. Moreover, these devices are typically more expensive to operate because an operator adjusts the filter.

A need, therefore, exists for an optical filter that does not require any external circuitry or power sources and is sufficiently small in size to be implemented within optical communication systems.

### SUMMARY

in accordance with the present disclosure, the problem of complex optical filters is solved by waveguides having optical pathways that passively restrict optical signals from traveling through the waveguides. Passively restricting optical signals avoids the complexities related to external electrical circuitry including operating software. The optical pathway passively restricts particular optical signals from passing through the waveguide by dispersing optical signals that contact the optical pathway's surface. In some embodiments of the present disclosure, the optical pathway may he designed to restrict particular optical signals from passing the waveguide based on an optical signal's frequency, phase or amplitude.

Particular embodiments may include passively restricting optical signals having a frequency that is greater than a critical frequency. Other embodiments may include transmitting optical signals through the optical pathway when the optical signal does not contact the optical pathway's surface. Further embodiments may include transmitting optical signals through the optical pathway when the optical signal frequency does not exceed a critical frequency.

Also, in accordance with the present disclosure, are methods for manufacturing efficient and less complex optical filters. These methods may include creating a waveguide having an optical pathway. It is to be understood that the preferred embodiment of this disclosure is an optical pathway in the shape of a slot in the waveguide. The optical pathway is designed and created in such a way that the pathway's surface that forms the slot may transmit a quantity of optical signals. The optical pathway's surface may be modified to passively restrict at least one optical signal. These optical pathway modifications may result in the optical pathway surface having a periodic shape. The modifications may be achieved using nano-technology techniques, such as photolithography. As a result, the optical filters described by the present disclosure may be manufactured on an integrated circuit and used, for example, in a modern communication system.

In some embodiments of the present disclosure, the optical pathway's surface may be modified to create a series of periodic steps located along the bottom surface of the waveguide. If desired, particular embodiments may optionally include modifying the optical pathway's surface by creating a series of periodic projections located along at least one wall of the waveguide. Similarly, other embodiments of the present disclosure may modify the optical pathway's surface by creating a waveguide bottom surface that varies continuously in height. In yet other embodiments of the present disclosure projections along at least one sidewall of the waveguide may be modified to vary continuously.

### BRIEF DESCRIPTION OF THE DRAWINGS

Other objects, features and advantages will occur to those skilled in the art from the following description and accompanying drawings, in which:

FIG. 1 is three-dimensional view of an exemplary embodiment of an optical filter in accordance with the present disclosure;

FIG. 2 is an isometric view of an exemplary embodiment of a slotted waveguide of the optical filter in accordance with the present disclosure;

FIG. 3 is a side view of an optical pathway having variable depths “A” and “B” of the optical filter of the present disclosure;

FIG. 4 is an illustration of several examples of possible cross-sectional views of the optical pathway of the optical filter hi accordance with the present disclosure;

FIG. 5 is an illustration of two optical signals passing through the waveguide of the optical filter wherein the optical signals have identical frequencies but different phases;

FIG. 6 is an illustration of two optical signals entering the waveguide of the optical filter wherein the optical signals have identical frequencies but different phases and only one of the optical signals passes through the waveguide; and

FIG. 7 is an illustration of a top view of a waveguide of the optical filter wherein a sinusoidal horizontal component may fit into an optical pathway of the waveguide.

### DETAILED DESCRIPTION

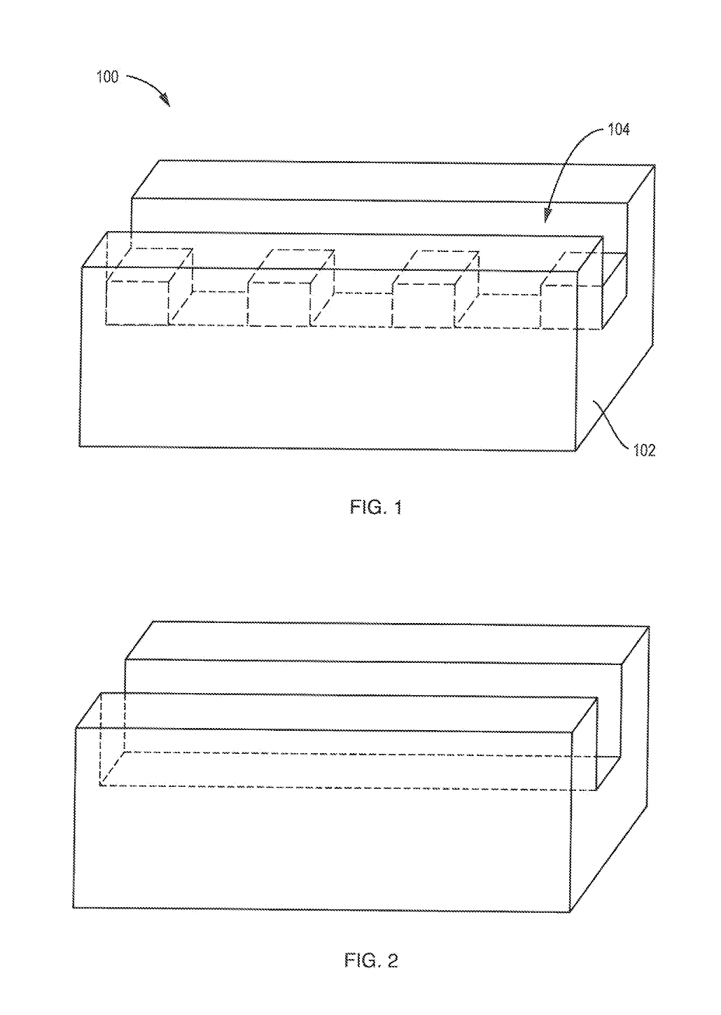

FIG. 1 is a three-dimensional view of an optical filter 100 according to an exemplary embodiment of the present disclosure. The optical filter 100 may include but is not limited to a waveguide 102 and an optical pathway 104. The optical pathway 104 passively restricts at least one optical signal from traveling through the waveguide 102.

The waveguide 102 may be manufactured from any material capable of transmitting optical signals from a light source, such as a laser or Light Emitting Diode (LED). In the exemplary embodiment of the present disclosure the waveguide 102 is manufactured from a silicon wafer. In alternate embodiments of the present disclosure, the waveguide 102 may be manufactured from a combination of germanium and silicon.

The waveguide 102 may be any shape capable of transmitting optical signals. FIG. 2 illustrates an exemplary embodiment of a waveguide 102 wherein the waveguide 102 has a rectangular-shaped slot. The slot has a surface that is defined by a floor and at least two sidewalls of the waveguide 102. Optical signals travel down the waveguide 102 within the slot. In other embodiments of the present disclosure the waveguide 102 may be shaped to create a ring resonator. The waveguide 102 includes an optical pathway 104 that transmits optical signals through the waveguide 102.

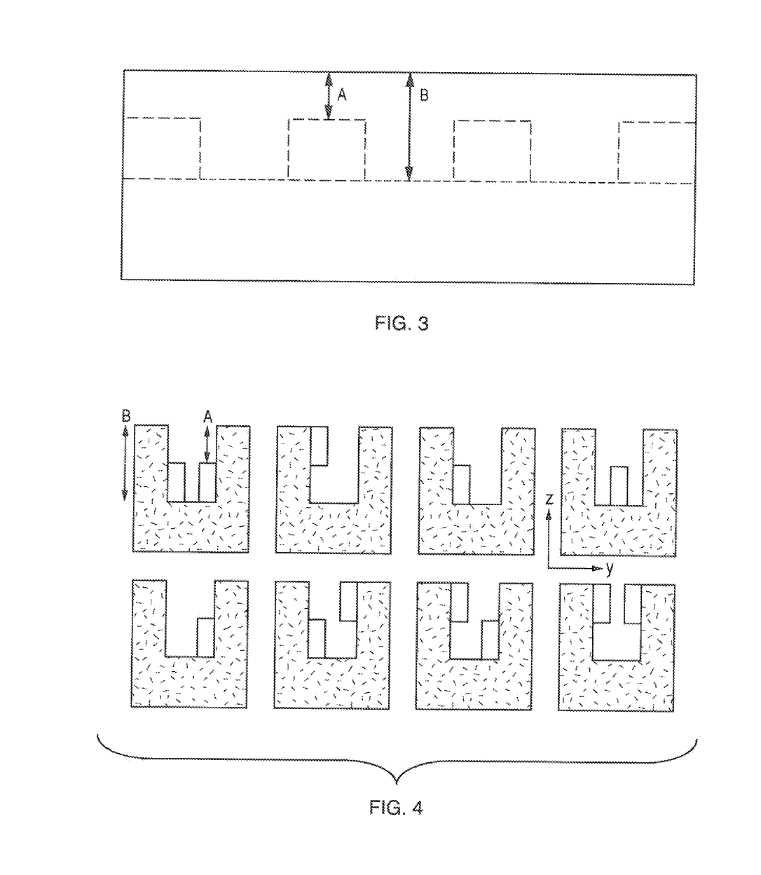

The optical pathway 104 defines a route for at least one optical signal to pass through the waveguide 102. The optical pathway 104 passively restricts an optical signal from traveling through the optical pathway 104 when the optical signal contacts the surface of the optical pathway 104. The surface of the optical pathway 104 may be defined by a floor and at least two sidewalls of the waveguide 102. The height of the floor may vary periodically allowing the optical filter 100 to passively restrict at least one optical signal from passing through the optical pathway 104. In the exemplary embodiment of the present disclosure, a section of the waveguide floor may be etched to a depth “A” creating a step within the optical pathway 104. Similarly, another section of the waveguide floor may be etched to a depth “B” creating a trough. This exemplary embodiment having steps and troughs that define the optical pathway 104 is shown on FIG. 3.

The steps and troughs that define the optical pathway 104 restrict sinusoidal optical signals having frequencies above a critical frequency. The length of the steps (in the direction of wave propagation) will determine the critical frequency of the optical filter 100. No modes with frequencies greater than the critical frequency will pass through the optical filter 100 without some unwanted energy loss. Not all frequencies less than the critical frequency will pass through the optical filter 100. Some modes with frequencies less than the critical frequency will also scatter off the one of the surfaces of the optical pathway 104. Only those optical signals that do not contact one of the optical pathway surfaces may pass through the optical filter 100 without dispersion.

The steps defining the optical pathway 104 may have any shape capable of restricting at least one optical signal from traveling through the waveguide 102. FIG. 4 depicts several examples of possible cross-sectional views of the optical pathway 104 for the optical filter 100. in alternate embodiments of the present disclosure, the distance between adjacent steps may be very small resulting in the floor of the waveguide 102 to vary almost continuously.

In yet other embodiments of the present disclosure the floor of the waveguide 102 may not have a quantity of steps but rather the depth of the floor may continuously change along the length of the waveguide 102. This depth may vary periodically along the length of the waveguide 102. The periodicity lay be determined, by at least one optical signal attribute that allows the signal to pass through the optical filter 100. In the alternative, the periodicity may also be determined by an optical signal attribute that does not allow the optical signal to pass through the optical filter 100.

For example the periodicity of the steps and troughs or the floor of the waveguide 102 determines a critical optical signal frequency for allowing desired optical signals to travel through the waveguide 102. The optical filter 100 will block any sinusoidal optical signal with a frequency greater than this critical frequency.

Other signal attributes, such as the optical signal phase, may be used to determine the exact location of the steps and troughs of a given periodicity along the waveguide 102. The steps and troughs may vary periodically to block optical signals having a phase that differs from an allowable phase from traveling through the waveguide 102. Similarly, the optical signal amplitude may be used to determine the depth of the slot (the height of the steps and troughs). The depth of the slot may vary periodically to block optical signals having an amplitude that is greater than a maximum allowable amplitude from traveling through the waveguide 102.

Other optical signal attributes that may he used to determine the shape of the floor and sidewalls of the waveguide 102 may include, but are not limited to the optical signal phase or amplitude, in the preferred embodiment of the present disclosure, those optical signals that are dispersed by contact with the steps and troughs of the slot's floor and the projections of the slot's sidewalls will not pass through the optical, filter 100.

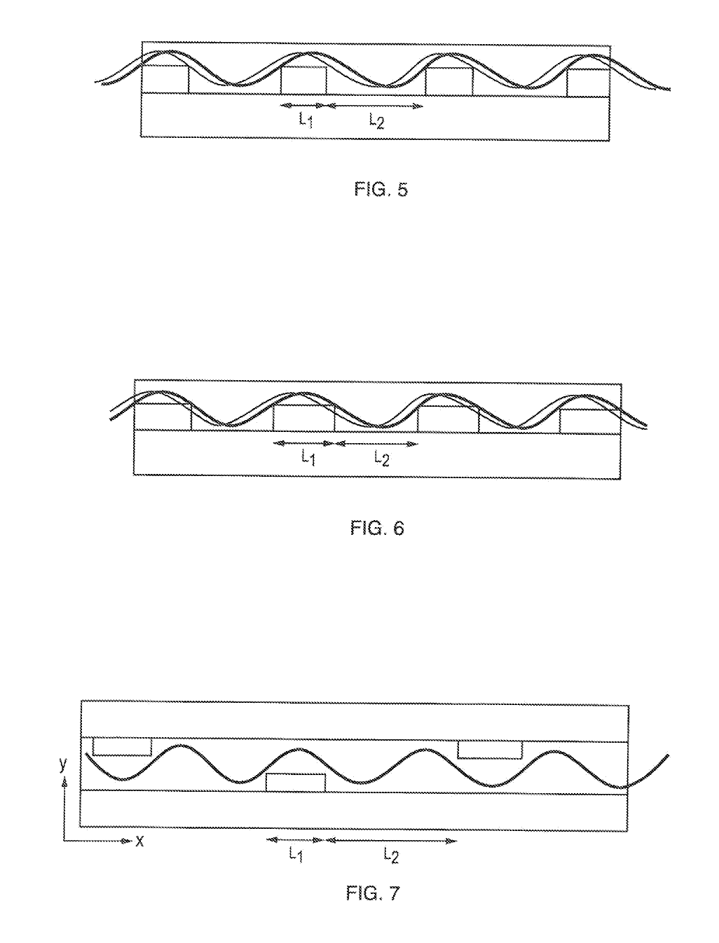

FIG. 3 illustrates an exemplary embodiment of the optical pathway 104 defined by a plurality of steps having a periodicity that is a function of a distance between each step and a length of each step located on the floor of the waveguide 102. In the present disclosure, the length of each step is defined by L₁ while the distance between steps is defined by L₂ (as seen in FIGS. 5 and 6), the sum of which is L, the periodicity of the optical pathway 104. If λ/2<L₁ then a sinusoidal optical signal will not pass through the optical filter 100. If L₁<λ/2 and mλ=L (where m=1, 2, . . . ) then a sinusoidal optical signal will pass through the optical filter 100.

Similarly, the steps and troughs defining the optical pathway 104 may be located on at least one of the sidewalls of the waveguide 102. These steps located on the sidewalls of the waveguide 102 are called projections. These projections may be located on at least one wall of the waveguide 102. In alternate embodiments of the present disclosure, a periodicity may be defined for a plurality of projections in the same manner as a periodicity was defined for the steps and toughs on the floor of the waveguide 102.

The length of the projections (in the direction of wave propagation) will determine the critical frequency of the optical filter 100. No modes with frequencies greater than the critical frequency will pass through the optical filter 100 without some unwanted energy loss. Not all frequencies less than the critical frequency will pass through the optical filter 100. Some modes with frequencies less than the critical frequency will also scatter off one of the surfaces of the optical pathway 104. Only those optical signals that do not contact one of the surfaces defining the optical pathway 104 may pass through the optical filter 100 without dispersion.

In alternate embodiments of the present disclosure, the distance between adjacent projections may be very small resulting in the sidewall of the waveguide 102 to vary almost continuously. In yet other embodiments of the present disclosure, the sidewalk may continuously change. Furthermore, the sidewalk may change with a fixed periodicity. The periodicity of the sidewalls may be designed so that sinusoidal optical signals with a frequency greater than a certain critical frequency will not pass through the optical filter 100.

In yet another embodiment of the present disclosure, the optical pathway 104 may be configured to influence an optical mode in the horizontal direction. FIG. 7 is a top view of an optical pathway 104, designed to only allow specific optical signals having a purely sinusoidal horizontal component to pass through the optical pathway 104. This type of configuration may be implemented in a three-dimensional optical filter.

FIG. 4 also depicts an optical pathway 104 that is defined by at least one step located, on the floor of the waveguide 102 and at least one projection located on a sidewall of the waveguide 102 to create a three-dimensional optical filter,

In other embodiments of the present disclosure the optical pathway 104 may be designed to allow more than one optical signal to travel through the waveguide 102. The optical pathway 104 may be created to allow only those optical signals within a desired range of frequencies and/or phases to pass through the waveguide 102. FIG. 5 illustrates two optical signals traveling through the optical pathway 104 of the waveguide 102 in accordance with an exemplary embodiment of this disclosure. The optical signals have the same frequency but different phases. Although the optical signals have different phases, the optical pathway 104 is configured to allow both optical signals to pass through the waveguide 102.

In contrast, FIG. 6 depicts two optical signals entering the optical pathway 104 of waveguide 102. The optical signals have the same frequency but different phases. In this embodiment of the present disclosure, the steps located on the floor of the waveguide 102 are configured to restrict the optical signal having the inappropriate phase from passing through the optical pathway 104 of the optical filter 100. Therefore, the phase at the location of the optical filter 100 is known and the filter can be used as a “phase reference”. This may be an important property in photonic circuits that contain elements, such as Mach-Zehnder interferometers, whose operation depends on the phase of the optical mode,

The following paragraphs of this disclosure present methods for filtering optical signals and manufacturing optical filters in accordance with the inventive subject matter of the present disclosure.

The problem of filtering optical signals without using external circuitry or inputs is solved by a method of filtering optical signals that transmits at least one optical signal through a waveguide having an optical pathway. The optical signal may travel through the optical pathway when the optical signal does not contact the surface of the optical pathway. Other optical signals are restricted from passing through the waveguide when those signals contact any one of the optical pathway surfaces causing the optical signals to disperse. Further embodiments of the present disclosure may include modulating at least one optical signal to adjust the signal amplitude to prevent the optical signal from contacting the surface of the optical pathway.

In other methods of the present disclosure, the optical signal may be transmitted through the optical pathway when the optical signal has a frequency that does not exceed a critical frequency. Other methods for filtering optical signals may also include modulating at least one optical signal to achieve a signal frequency that does not exceed a critical frequency.

In yet other methods of the present disclosure, the method of filtering optical signals may include restricting at least one optical signal from traveling through an optical pathway of a waveguide. The optical signal is prevented from traveling through the waveguide when the optical signal contacts the surface of the optical pathway causing the optical signal to disperse. This method of filtering optical signals may also include passively restricting at least one optical signal from traveling through the waveguide when the optical signal has a frequency that is greater than a critical frequency.

This method for filtering optical signals may also include transmitting at least one optical signal through the optical pathway. The optical signal may be transmitted through the optical pathway when the optical signal passes through the optical pathway without contacting the optical pathway's surface. Alternate methods may also include transmitting at least one optical signal through the optical pathway when the optical signal has a frequency that does not exceed a critical frequency.

The present disclosure also provides methods for manufacturing optical filters. Methods for manufacturing an optical filter may include creating a waveguide having an optical pathway. The waveguide may be manufactured by etching a slot within a silicon wafer to create the waveguide's optical pathway. Other methods for manufacturing the waveguide may implement photolithographic techniques. Such techniques may include applying a photoresist layer onto the silicon wafer to protect particular areas of the silicon wafer during the etching process to create the optical pathway.

In some embodiments of the present disclosure, the waveguide may be manufactured using germanium. Germanium may be grown-on the exposed areas of the substrate to form the waveguide sidewalls. In the preferred embodiment of the present disclosure a quantity of germanium may be grown on the two closely-space strips of the exposed silicon substrate to form the sidewalls of the waveguide.

Further teachings and descriptions of the methods for growing a quantity of germanium on a substrate are provided in the contents of U.S. Application Publication No. 2011/0036289 A1 filed Aug. 11, 2009, which is incorporated herein by reference. This reference and all other referenced patents and applications are incorporated herein by reference in their entirety, Furthermore, where a definition or use of a term in a reference, which is incorporated by reference herein is inconsistent or contrary to the definition of that term provided herein, the definition of that term provided herein applies and the definition of that term in the reference does not apply.

Methods for manufacturing the optical filter may also include modifying the surface of the optical pathway. For example, photo and etch steps may be used to define and etch the optical pathway at a given depth “A”. The depth of the optical pathway in the waveguide is measured from the top of the waveguide and is assumed to be less than the overall height of the waveguide. A light-sensitive material, photoresist, may be applied to the surface of the optical pathway. By means of a photolithographic mask, the photoresist is exposed and developed. If the photoresist is positive, then the exposed regions will be soluble in the developer. Therefore, the regions of the photoresist applied to the optical pathway that are not exposed will remain and can be hardened. The regions of the photoresist that are exposed are to be removed.

A. second etch of the silicon may be performed, but to depth “B” that is greater than depth “A”. Some sections of the optical pathway will not be etched since they are protected by the hardened photoresist. The remaining sections of the optical pathway are to be etched to a depth “B”. The photoresist may be removed. In some embodiments of the present disclosure, the floor of the waveguide may be etched creating the optical pathway of the waveguide. In other methods for manufacturing the optical filter, the sidewalls of the waveguide may be etched creating the optical pathway of the waveguide. In yet other methods, both the floor and sidewalls of the waveguide may be etched creating the optical pathway of the waveguide.

While the present disclosure has been described in connection with the preferred embodiments of the various figures, it is understood that other similar embodiments may be used or modifications or additions may he made to the described embodiments for performing the same function of the present disclosure without deviating therefrom. Therefore, the present disclosure should not be limited to any single embodiment, but rather construed in breadth and scope in accordance with the recitation of the appended claims.

It may be possible to execute the activities described herein in an order other than the order described. And various activities described with respect to the methods identified herein can be executed in repetitive, serial, or parallel fashion.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

It is emphasized that the Abstract is provided to comply with 37 C.F.R. §132(b) requiring an Abstract that will allow the reader to quickly ascertain the nature and gist of the technical disclosure. It is submitted with the understanding that it will not be used to interpret or limit the scope or meaning of the claims.

Other embodiments will occur to those skilled in the art and are within the following claims.

What is claimed is:

1. An optical filter comprising:
a waveguide having an optical pathway wherein the optical pathway passively restricts at least one optical signal from traveling through the waveguide,

2. The optical filter of claim I wherein the optical signal is passively restricted from traveling through the optical pathway when the optical signal contacts at least one surface of the optical pathway.

3. The optical filter of claim 2 wherein the optical pathway is defined by a floor and at least two walls of the waveguide.

4. The optical filter of claim 3 further comprising a plurality of steps having a periodicity that is a function of a distance between each step and a length of each step located on the floor of the waveguide.

5. The optical filter of claim 3 further comprising a plurality of projections having a periodicity that is a function of a distance between each projection and a length of each projection located on the at least one wall of the waveguide.

6. The optical filter of claim 4 further comprising a plurality of projections having a periodicity that is a function of a distance between each projection and a length of each projection located on at least one wall of the waveguide.

7. The optical filter of claim 3 wherein the floor has a surface that passively restricts the flow of at least one optical signal from traveling through the waveguide.

8. An optical filter comprising:
a waveguide having a slot wherein t least one optical signal passes through the waveguide when the optical signal does not contact a surface defining the slot.

9. The optical filter of claim 8 wherein the surface of the slot is defined by a floor and at least two sidewalls of the waveguide.

10. The optical filter of claim 9 wherein the floor has a plurality of periodic steps and a plurality of periodic troughs.

11. The optical filter of claim 9 wherein the floor periodically varies to block at least one optical signal having a signal attribute from traveling through the waveguide.

12. The optical filter of claim 11 wherein the signal attribute is a frequency that is greater than a critical frequency.

13. The optical filter of claim 11 wherein the signal attribute is an amplitude that is greater than a maximum allowable amplitude.

14. The optical filter of claim 11 wherein the signal attribute is a phase that differs from an allowable phase.

15. A method of filtering optical signals comprising:
restricting at least one optical signal from traveling through a waveguide having an optical pathway wherein at least one optical signal disperses when the optical signal contacts at least one surface defining the optical pathway.

16. The method of claim 15 wherein at least one optical signal is passively restricted from traveling through the waveguide when the optical signal has a frequency that is greater than a critical frequency.

17. The method of claim 15 further comprising transmitting at least one optical signal through the optical pathway of the waveguide.

18. The method of claim 17 wherein at least one optical signal is transmitted through the optical pathway when the optical signal passes through the optical pathway without contacting the surface defining the optical pathway.

19. The method of claim 17 wherein at least one optical signal is transmitted through the optical pathway when the optical signal has a frequency that does not exceed a critical frequency.

20. The method of claim 15 further comprising identifying a phase of at least one optical signal by restricting the optical signal from traveling through the optical pathway of the waveguide.

21. A method of filtering optical signals comprising:
transmitting at least one optical signal through a waveguide having an optical pathway defined by a plurality of surfaces wherein the optical signal passes through the optical pathway when the optical signal does not contact the surfaces defining the optical pathway.

22. The method of claim 21 wherein at least one optical signal is transmitted through the optical pathway when the optical signal has a frequency that does not exceed a critical frequency.

23. The method of claim 22 further comprising modulating the optical signal to adjust the frequency not to exceed the critical frequency.

24. The method of claim 21 further comprising modulating at least one optical signal having an amplitude wherein the amplitude is adjusted to prevent the optical signal from contacting the surfaces defining the optical pathway.

25. The method of claim 21 further comprising identifying a phase of at least one optical signal by restricting the optical signal from traveling through the optical pathway of the waveguide.

26. A method for manufacturing an optical filter comprising:
creating a waveguide having an optical pathway wherein the optical pathway transmits a quantity of optical signals; and
modifying the optical pathway wherein the optical pathway varies periodically to passively restrict at least one optical signal.

27. The method of claim 26 wherein the optical pathway is modified by creating a series of periodic steps located along a bottom surface of the waveguide.

28. The method of claim 26 wherein the optical pathway is modified by creating a series of periodic projections located along at least one wall of the waveguide.

29. The method of claim 26 wherein the optical pathway is modified by creating a continuous bottom surface of the waveguide that periodically varies in height.

30. An optical circuit comprising:
waveguide having an optical pathway wherein the optical pathway passively restricts at least one optical signal having a phase from traveling through the waveguide o identify the phase of the optical signal.
